(19) United States
(12) Patent Application Publication
(10) Pub. No.: US 2025/0355269 A1
(43) Pub. Date: Nov. 20, 2025

(54) PHOTONIC INTEGRATED CIRCUIT AND CONTROLLING METHOD THEREOF FOR VERTICAL OPTICAL COMPUTING

(71) Applicant: Taiwan Semiconductor Manufacturing Company, Ltd., Hsinchu (TW)

(72) Inventors: Shinn-Sheng YU, Hsinchu (TW); Jui-Lin CHAO, Hsinchu (TW); Chih-Yuan CHANG, Hsinchu (TW); Hsing-Kuo HSIA, Hsinchu (TW)

(73) Assignee: Taiwan Semiconductor Manufacturing Company, Ltd., Hsinchu (TW)

(21) Appl. No.: 18/663,771

(22) Filed: May 14, 2024

(51) Int. Cl. G02B 27/42

(52) U.S. Cl. CPC G02B 27/4233

(57) ABSTRACT

A photonic integrated circuit including a first 4f system, a leader laser, a first diffractive optical element, a second 4f system, a plurality of first vertical-cavity surface-emitting lasers, a plurality of second vertical-cavity surface-emitting lasers, a plurality of second diffractive optical elements, a third diffractive optical element and a plurality of detectors is provided. The leader laser is disposed at the object plane of the first 4f system. The first diffractive optical element is disposed at the pupil plane of the first 4f system. The plurality of first vertical-cavity surface-emitting lasers and the plurality of second vertical-cavity surface-emitting lasers are disposed at the object plane of the second 4f system. The plurality of second diffractive optical elements and the third diffractive optical element are disposed at the pupil plane of the second 4f system. The plurality of detectors are disposed at the image plane of the second 4f system.

### BACKGROUND

The disclosure relates in general to photonic integrated circuit (PIC), and more particularly to a photonic integrated circuit and a controlling method thereof for vertical optical computing (VOC).

The electrons computing technology could be used for implementing a deep neural network (DNN) for artificial intelligence/machine learning (AI/ML) applications; more specifically, for handling the vector-matrix multiplication (the multiply-and-accumulate (MAC) operation being the building block), which is the most computationally intensive in the DNN if electronic integrated circuits (EIC) are used.

The requirements of AI/ML far exceed the Moore's law. Even if the industry can keep up with the pace of Moore's law, the projected power consumption is not sustainable. We need to find new schemes to do the computation needed by AI/ML efficiently.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates the multiply operation of two numbers x and w by homodyne detection employing a beam splitter.

FIG. 2 illustrates the multiply operation of two numbers x and w without using a beam splitter.

FIG. 3 shows a 3D photonic integrated circuit (PIC) for vertical optical computing (VOC).

FIGS. 4-9 illustrate the 2-Fan-out vertical optical computing (VOC).

FIG. 10 illustrates a diffractive optical element in a 4f system.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

This disclosure is related to the optical computing technology. The optical computing technology is an innovative way to perform the multiply-and-accumulate (MAC) operation with high performance and efficiency for the deep neural network (DNN) adopted in the artificial intelligence/machine learning (AI/ML) applications.

According to Moore's law, the number of transistors inside a chip (of a fixed area) doubles every 2 years. The power consumption of a transistor also reduces, however, at a lower rate (being halved every 2.2 years); thus, the power consumption of a chip increases gradually from one to the next generation. According to the projection of the trend, when we reach zettascale computing in 2035, the projected power consumption would be 500 MW, which is of the order that a nuclear power plant can deliver. Therefore, the optical computing technology is needed in the future.

Consider a deep neural network (DNN) for artificial intelligence (AI)/machine learning (ML) applications. Consider two consecutive layers in the DNN, named as the first layer and the second layer, respectively. Say the first layer has K neurons and the second layer has N neurons. For a fully-connected DNN, the activations of the second layer (denoted as Y, which is formulated as a 1×N matrix, denoted as Y_{1×N}) are related to the activations of the first layer (denoted as X, which is formulated as a 1×K matrix, denoted as X_{1×K}) through the following matrix equation:

$${X}_{1 \times K} {W}_{K \times N} = [ \begin{matrix}{x}_{1 , 1} & {x}_{1 , 2} & ⋯ & {x}_{1 , k} & ⋯ & {x}_{1 , K}\end{matrix} ] [ \begin{matrix}{w}_{1 , 1} & {w}_{1 , 2} & ⋯ & {w}_{1 , n} & ⋯ & {w}_{1 , N} \\ {w}_{2 , 1} & & & & & \\ ⋯ & & & & & \\ {w}_{k , 1} & & & {w}_{k , n} & & \\ ⋯ & & & & & \\ {w}_{K , 1} & & & & & {w}_{K , N}\end{matrix} ] \qquad ( 1 )$$

$$= [ \begin{matrix}{X}_{1} \cdot {W}_{1} & {X}_{1} \cdot {W}_{2} & ⋯ & {X}_{1} \cdot {W}_{n} & ⋯ & {X}_{1} \cdot {W}_{N}\end{matrix} ]$$

$$= {Y}_{1 \times N} .$$

Here, the matrix W_{K×N} is a collection of weighting factors relating the two layers. X_{1×K} consists of one row, which can be regarded as one vector (row vector) and is denoted as X₁. W_{K×N} consists of N columns, which can be regarded as N vectors (column vectors) and are denoted as W₁, W₂, . . . , Wₙ, . . . , W_{N}, respectively. The n-th element of Y_{1×N} (denoted as yin) is the inner product of X₁ and Wₙ, shown explicitly as

$${y}_{1 , n} = {X}_{1} \cdot {W}_{n} = {x}_{1 , 1} {w}_{1 , n} + {x}_{1 , 2} {w}_{2 , n} + ⋯ + {x}_{1 , k} {w}_{k , n} + ⋯ + {x}_{1 , K} {w}_{K , n} . \qquad ( 2 )$$

The inner product of two vectors is essentially the same as the multiply-accumulate (MAC) operation of two lists of numbers representing the two vectors. Since the first matrix in Equation (1) consists of only one row, we may say Equation (1) describes a vector-matrix multiplication.

The MAC operation is the most computationally intensive in a DNN if done by electrons; however, it is almost free if done by photons. As will be shown later, the MAC operation can be done passively by homodyne detection.

In one embodiment, X₁ and each column of W_{K×N}, i.e., W₁, W₂, . . . , Wₙ, . . . , W_{N} are respectively encoded in K time steps to the amplitude or phase of the emission of vertical-cavity surface-emitting lasers (VCSEL). All employed VCSELs are injection-locked using a leader laser to achieve the needed coherence between them for homodyne detection.

Furthermore, a diffractive optical element (DOE) is used to duplicate X₁ the number of copies equal to the number of columns of W_{K×N} (called X₁ fan-out) to maximize computational parallelism without any extra resources.

In another embodiment, the setup of optical computing is implemented by free-space optics, which is flexible to adjust, suitable for concept demonstration in the lab; however, is bulky, non-portable, and prone to drift.

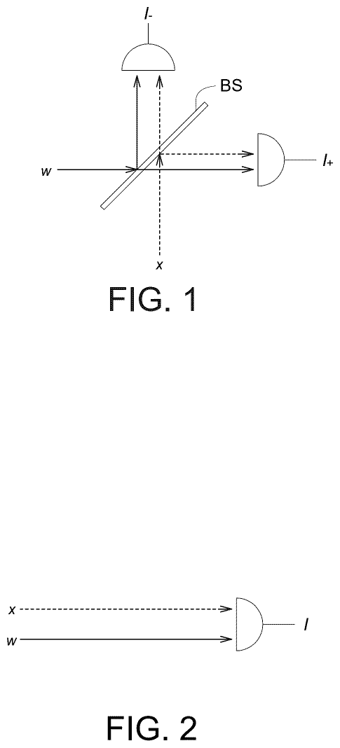

Please refer to FIG. 1, which shows the setup of homodyne detection for performing the multiply operation of two numbers x and w, each encoded with one light beam. Note that a 50/50 beam splitter (BS) is used.

More explicitly,

$$x = {a}_{x} {e}^{i {φ}_{x}} {e}^{- i ω t}$$

aₓ and φₓ are respectively the amplitude and phase of x.

$$w = {a}_{x} {e}^{i {φ}_{x}} {e}^{- i ω t} .$$

a_{w} and φ_{w} are respectively the amplitude and phase of w. The two light beams encoding x and w have the same frequency ω. If the signals of the two input ports of the BS are x and w, then the signals of the two output ports of the BS are x′ and w′, which are related to x and w by

$$[ \begin{matrix}{x}^{′} \\ {w}^{′}\end{matrix} ] = \frac{1}{\sqrt{2}} [ \begin{matrix}1 & 1 \\ 1 & - 1\end{matrix} ] [ \begin{matrix}x \\ w\end{matrix} ] . \qquad ( 3 )$$

The intensities of the two output ports are

$${I}_{+} = {\vert {x}^{′} \vert}^{2} = {\vert \frac{x + w}{\sqrt{2}} \vert}^{2} = \frac{[ x + w ] [ {x}^{*} + {w}^{*} ]}{2} = \frac{{\vert x \vert}^{2} + 2 Re [ {xw}^{*} ] + {\vert w \vert}^{2}}{2} \qquad ( 4 )$$

$$and$$

$${I}_{-} = {\vert {w}^{′} \vert}^{2} = {\vert \frac{x - w}{\sqrt{2}} \vert}^{2} = \frac{[ x - w ] [ {x}^{*} - {w}^{*} ]}{2} = \frac{{\vert x \vert}^{2} - 2 Re [ {xw}^{*} ] + {\vert w \vert}^{2}}{2} . \qquad ( 5 )$$

The difference of the intensities of the two output ports is

$$Δ I = {I}_{+} - {I}_{-} = 2 Re [ {xw}^{*} ] , \qquad ( 6 )$$

which is related to the result of the multiply operation of x and w.

If phase encoding is adopted, |x|² and |w|² are constant; thus, we can use only one detector and remove |x|² and |w|² by post-detection data processing. We just let the two light beams (one encoding x; the other encoding w) be overlapped in space and hit a single detector, as shown in FIG. 2. Explicitly,

$$I = {\vert x + w \vert}^{2} = [ x + w ] [ {x}^{*} + {w}^{*} ] = {\vert x \vert}^{2} + 2 Re [ {xw}^{*} ] + {\vert w \vert}^{2} . \qquad ( 7 )$$

Note that after removing |x|² and |w|², the result is the same as that obtained by standard homodyne detection with a beam splitter and two detectors.

With the help of an integrator (e.g., a capacitor) attached to the detector to integrate the photocurrent, one can perform the MAC operation on two lists of numbers X and W, i.e., find the value of X. W. Explicitly, X=[X₁ x₂ . . . xₖ . . . x_{K}]; W=[w₁ w₂ . . . w_{K}]; X·W=x₁w₁+x₂w₂+ . . . +xₖwₖ+ . . . +X_{K}W_{K}. Note that the interval of integration is the duration when X and W are encoded. Recall that X and W are respectively encoded in K time steps to the phases of the emissions of two different VCSELs. Note that a controller is needed to synchronize the encodings of X and W.

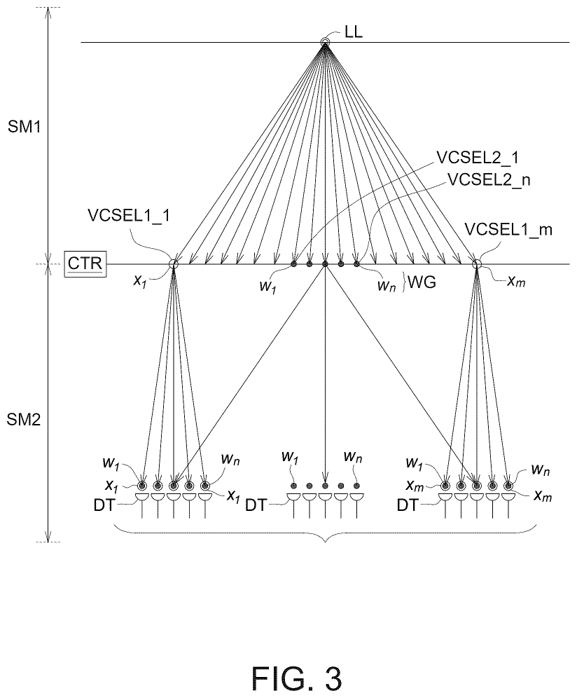

Please refer to FIG. 3, which shows a 3D photonic integrated circuit (PIC) 100 for optical computing. Since the optical components of the 3D PIC are stacked vertically, the PIC is designated as a PIC for performing vertical optical computing. In one embodiment, the 3D PIC 100 for performing vertical optical computing is used to provide a compact and robust solution for optical computing in AI/ML applications.

Recall from Equation (1) that we can obtain the activations of the next layer from the activations of the current layer through a vector-matrix multiplication, i.e., X_{1×K}W_{K×N}=Y_{1×N}. Once W_{K×N} has been set up, we seek to further enhance computational efficiency by handling several, say M, input vectors simultaneously, in which case we need to perform a matrix-matrix multiplication:

$${X}_{1 \times K} {W}_{K \times N} = [ \begin{matrix}{x}_{1 , 1} & {w}_{1 , 2} & ⋯ & {x}_{1 , k} & ⋯ & {x}_{1 , K} \\ {x}_{2 , 1} & & & & & \\ ⋯ & & & & & \\ {x}_{m , 1} & & & {x}_{k , m} & & \\ ⋯ & & & & & \\ {x}_{M , 1} & & & & & {x}_{M , K}\end{matrix} ] [ \begin{matrix}{w}_{1 , 1} & {w}_{1 , 2} & ⋯ & {w}_{1 , n} & ⋯ & {w}_{1 , N} \\ {w}_{2 , 1} & & & & & \\ ⋯ & & & & & \\ {w}_{k , 1} & & & {w}_{k , n} & & \\ ⋯ & & & & & \\ {w}_{K , 1} & & & & & {w}_{K , N}\end{matrix} ] \qquad ( 8 )$$

$$= [ \begin{matrix}{X}_{1} \cdot {W}_{1} & {X}_{1} \cdot {W}_{2} & ⋯ & {X}_{1} \cdot {W}_{n} & ⋯ & {X}_{1} \cdot {W}_{N} \\ {X}_{2} \cdot {W}_{1} & & & & & \\ ⋯ & & & & & \\ {X}_{m} \cdot {W}_{1} & & & & & \\ ⋯ & & & & & \\ {X}_{M} \cdot {W}_{1} & & & & & {X}_{M} \cdot {W}_{N}\end{matrix} ]$$

$$= {Y}_{M \times N} .$$

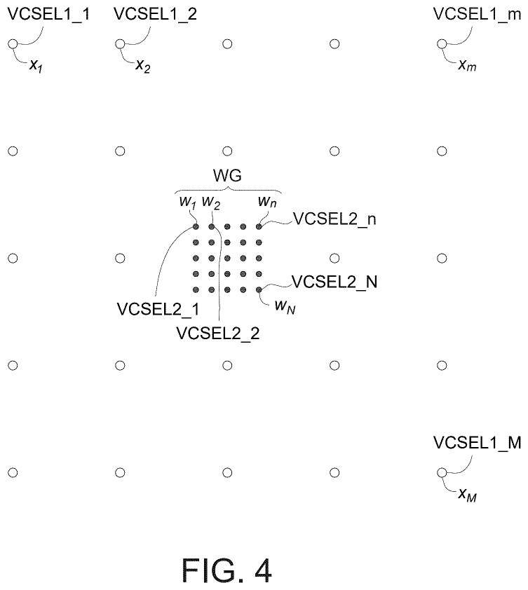

The above matrix-matrix multiplication can be regarded as M vector-matrix multiplications done concurrently with M input vectors X₁, X₂, . . . , Xₘ, . . . , XM (i.e., the M rows of X_{M×K}), respectively. The 3D photonic integrated circuit (PIC) 100 can realize a matrix-matrix multiplication in a single shot using 2-fold fan-out, as shown in FIG. 4 to FIG. 9.

The photonic integrated circuit (PIC) 100 includes a first 4f system SM1 and a second 4f system SM2. In the first 4f system SM1, there exist a leader laser LL and a first diffractive optical element DOE1. The first diffractive optical element DOE1 is disposed below the leader laser LL for producing a plurality of copies of the leader laser LL.

In the second 4f system SM2, there exist a plurality of first vertical-cavity surface-emitting lasers VCSEL1_1, VCSEL1_2, . . . , VCSEL1_m, . . . , VCSEL1_M, a plurality of second vertical-cavity surface-emitting lasers VCSEL2_1, VCSEL2_2, . . . , VCSEL2_n, . . . , VCSEL2_N, a plurality of second diffractive optical elements DOE2, a third diffractive optical element DOE3, and a plurality of detectors DT. Each of X₁, X₂, . . . , Xₘ, . . . , X_{M} is encoded with one of the plurality of first vertical-cavity surface-emitting lasers. One of the plurality of second diffractive optical elements DOE2 is disposed below each of the plurality of first vertical-cavity surface-emitting lasers encoding one of X₁, X₂, . . . , Xₘ, . . . , X_{M}. Each of W₁, W₂, . . . , Wₙ, . . . , W_{N} is encoded with one of the plurality of second vertical-cavity surface-emitting lasers. The third diffractive optical element DOE3 is disposed below the plurality of second vertical-cavity surface-emitting lasers encoding W₁, W₂, . . . , Wₙ, . . . , W_{N}.

Each of X₁, X₂, . . . , Xₘ, . . . , X_{M} is encoded with one of the plurality of first vertical-cavity surface-emitting lasers. One of the plurality of second diffractive optical elements DOE2 is disposed below each of the plurality of first vertical-cavity surface-emitting lasers encoding one of X₁, X₂, . . . , Xₘ, . . . , X_{M} to produce a plurality of copies of each of X₁, X₂, . . . , Xₘ, . . . , X_{M}.

Each of W₁, W₂, . . . , Wₙ, . . . , Wy is encoded with one of the plurality of second vertical-cavity surface-emitting lasers. The third diffractive optical element DOE3 is disposed below the plurality of second vertical-cavity surface-emitting lasers encoding W₁, W₂, . . . , Wₙ, . . . . W_{N} to produce a plurality of copies of the group of W₁, W₂, . . . , Wₙ, . . . , W_{N}. The copies of each of X₁, X₂, . . . , Xₘ, . . . , X_{M} are overlapped (one on one) with one of the copies of the group of W₁, W₂, . . . , Wₙ, . . . , W_{N}.

The plurality of detectors DT (including a capacitor) are disposed below the plurality of second diffractive optical elements DOE2 and the third diffractive optical element DOE3 for detecting a plurality of computing results of MAC operations of one of X₁, X₂, . . . , Xₘ, . . . , X_{M} and one of W₁, W₂, . . . , Wₙ, . . . , W_{N}.

Referring to FIG. 4, the plurality of first vertical-cavity surface-emitting lasers VCSEL1_1, VCSEL1_2, . . . , VCSEL1_m, . . . , VCSEL1_M encode X₁, X₂, . . . , Xₘ, . . . , X_{M}, respectively. The plurality of second vertical-cavity surface-emitting lasers VCSEL2_1, VCSEL2_2, . . . , VCSEL2_n, . . . , VCSEL2_N encode W₁, W₂, . . . , Wₙ, . . . , W_{N}, respectively.

The second vertical-cavity surface-emitting lasers VCSEL2_1, VCSEL2_2, . . . . VCSEL2_n, . . . , VCSEL2_N are arranged in a matrix. The first vertical-cavity surface-emitting lasers VCSEL1_1, VCSEL1_2, . . . , VCSEL1_m, . . . , VCSEL1_M are arranged in a matrix, except at the places where the second vertical-cavity surface-emitting lasers are located.

The first vertical-cavity surface-emitting lasers VCSEL1_1, VCSEL1_2, . . . , VCSEL1_m, . . . , VCSEL1_M surround the second vertical-cavity surface-emitting lasers VCSEL2_1, VCSEL2_2, . . . , VCSEL2_n, . . . , VCSEL2_N. The spacing among the first vertical-cavity surface-emitting lasers VCSEL1_1, VCSEL1_2, . . . , VCSEL1_m, . . . , VCSEL1_M is larger than the spacing among the second vertical-cavity surface-emitting lasers VCSEL2_1, VCSEL2_2, . . . , VCSEL2_n, . . . , VCSEL2_N.

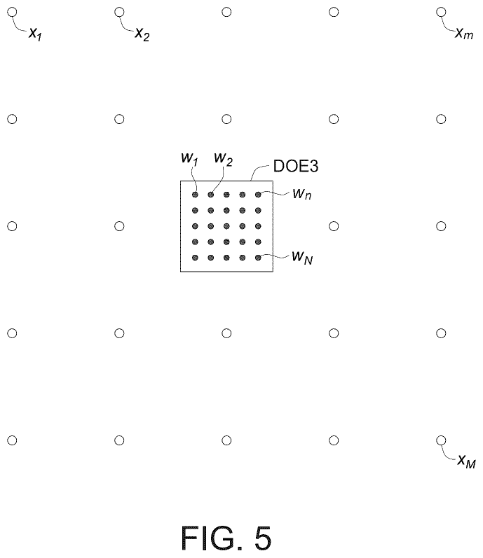

Referring to FIG. 5, the third diffractive optical element DOE3 is used to achieve the fan-out of the group of W₁, W₂, . . . , Wₙ, . . . , W_{N}. The third diffractive optical element DOE3 is equipped with gratings of smaller periods, leading to larger diffraction angles.

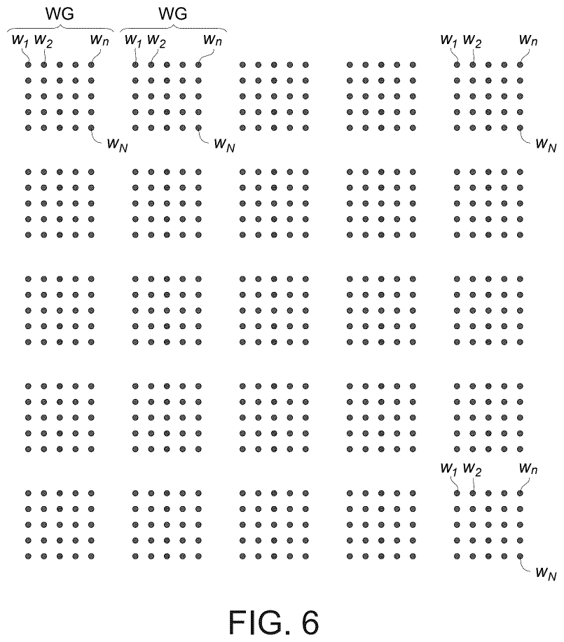

Referring to FIG. 6, after fan-out, a plurality of copies of the group of W₁, W₂, . . . , Wₙ, . . . , W_{N} are achieved.

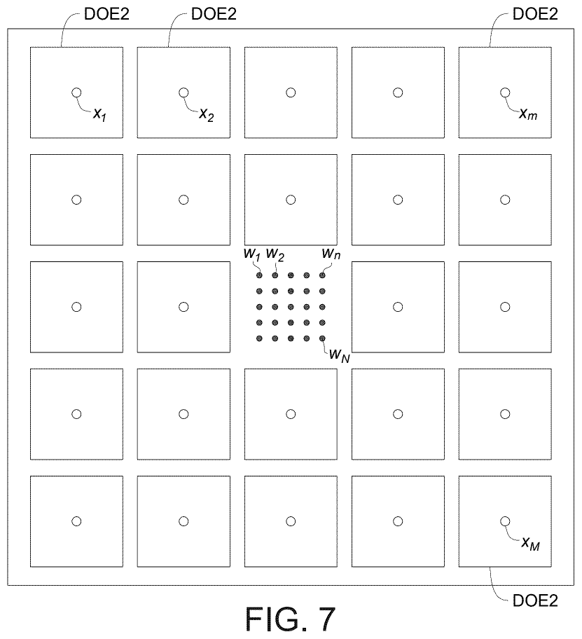

Referring to FIG. 7, one of the plurality of second diffractive optical elements DOE2 is used to achieve the fan-out of each of X₁, X₂, . . . , Xₘ, . . . , X_{M}. The plurality of second diffractive optical elements DOE2 are equipped with gratings of larger periods, leading to smaller diffraction angles.

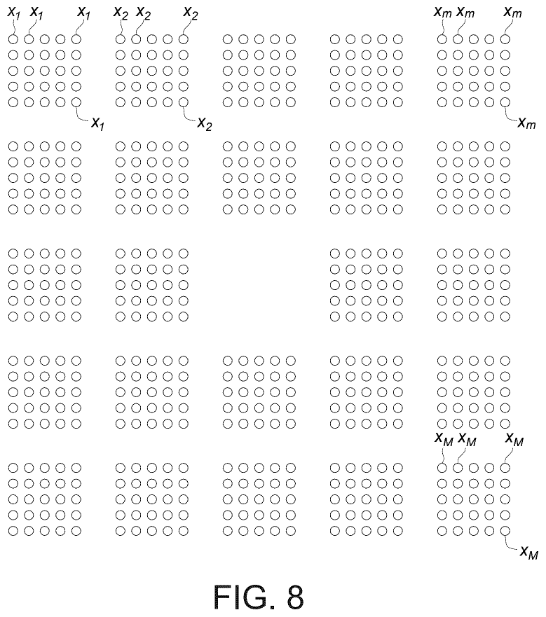

Referring to FIG. 8, after fan-out, a plurality of copies of each of X₁, X₂, . . . , Xₘ, . . . . X_{M} are achieved.

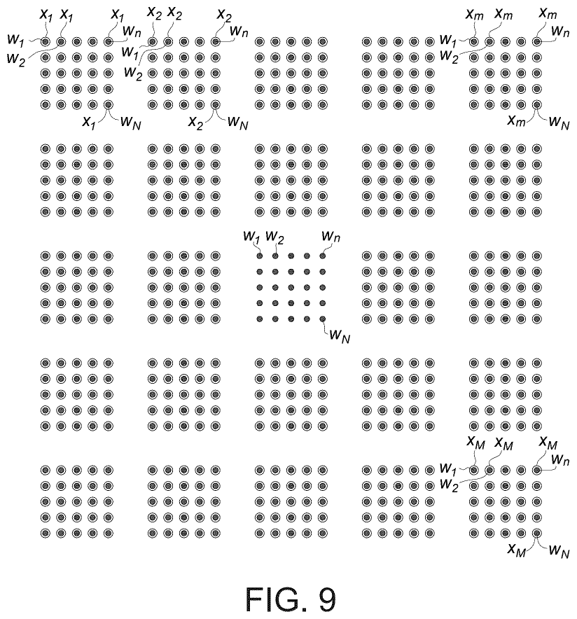

Referring to FIG. 9, the overlap of the copies of the group of W₁, W₂, . . . , Wₙ, . . . . W_{N} and the copies of each of X₁, X₂, . . . , Xₘ, . . . , X_{M} are obtained. One of the plurality of detectors DT (shown in FIG. 3) is placed below each of the overlapped pairs including one of X₁, X₂, . . . , Xₘ, . . . , X_{M} and one of W₁, W₂, . . . , Wₙ, . . . , W_{N}.

Please refer to FIG. 3 for the plurality of second diffractive optical elements DOE2 and the third diffractive optical element DOE3. The diffraction angles of the plurality of second diffractive optical elements DOE2 are smaller than the diffraction angles of the third diffractive optical element DOE3. The diffraction angles of the first diffractive optical element DOE1 is substantially equal to the diffraction angles of the plurality of second diffractive optical elements DOE2.

The number of diffraction orders of each of the plurality of second diffractive optical elements DOE2 is equal to or greater than N. The number of diffraction orders of the third diffractive optical element DOE3 is equal to or greater than M.

To implement a large DNN model, each of the plurality of second diffractive optical elements DOE2 needs to have a small diffraction angle between adjacent diffraction orders, e.g., below 1 degree.

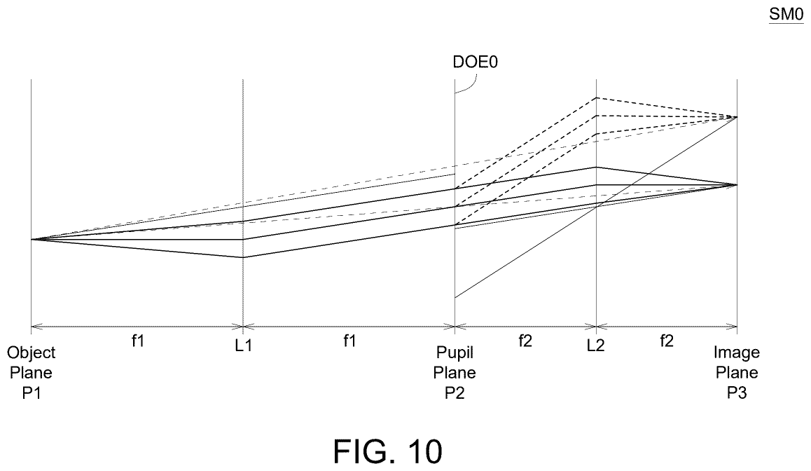

Please refer to FIG. 10, which illustrates a diffractive optical element DOE0 in a 4f system SM0. The 4f system SM0 is an optical imaging system comprising a first lens L1 (having a focal length f1) and a second lens L2 (having a focal length f2). The object plane of the optical imaging system is located at the front focal plane of the first lens. The pupil plane of the optical imaging system is located at the back focal plane of the first lens, which is also the front focal plane of the second lens. The image plane of the optical imaging system is located at the back focal plane of the second lens.

If a diffractive optical element DOE0 is inserted at the pupil plane of the 4f system SM0, N diffraction orders is produced for each beam (a plane wave) incident on it; thus, N images is produced in the image plane for each object in the object plane.

The optical layout shown in FIG. 10 can be adopted in the scheme of 2-fold fan-out shown in FIG. 3. For example, as shown in FIG. 3, a leader laser LL can be disposed at the object plane of the first 4f system SM1. A first diffractive optical element DOE1 can be disposed at the pupil plane of the first 4f system SM1. A plurality of first vertical-cavity surface-emitting lasers VCSEL1_1, VCSEL1_2, . . . , VCSEL1_m, . . . , VCSEL1_M can be disposed at the object plane of the second 4f system SM2, which is also the image plane of the first 4f system SM1. A plurality of second vertical-cavity surface-emitting lasers VCSEL2_1, VCSEL2_2, . . . , VCSEL2_n, . . . , VCSEL2_N can be disposed at the object plane of the second 4f system SM2. Second diffractive optical elements DOE2 can be disposed at the pupil plane of the second 4f system SM2. A third diffractive optical element DOE3 can be disposed at the pupil plane of the second 4f system SM2. A plurality of detectors DT can be disposed at the image plane of the second 4f system SM2.

Furthermore, please refer to FIG. 3, in which the photonic integrated circuit (PIC) 100 for vertical optical computing (VOC) may further include a controller CTR. The controller CTR is connected to the first vertical-cavity surface-emitting lasers VCSEL1_1, VCSEL1_2, . . . , VCSEL1_m, . . . , VCSEL1_M and the second vertical-cavity surface-emitting lasers VCSEL2_1, VCSEL2_2, . . . , VCSEL2_n, . . . , VCSEL2_N to change the amplitudes or phases of their emitted light beams to encode X₁, X₂, . . . , Xₘ, . . . , X_{M} and W₁, W₂, . . . , Wₙ, . . . , W_{N}, respectively. In one embodiment, the controller CTR modulates the first vertical-cavity surface-emitting lasers VCSEL1_1, VCSEL1_2, . . . , VCSEL1_m, . . . , VCSEL1_M and the second vertical-cavity surface-emitting lasers VCSEL2_1, VCSEL2_2, . . . , VCSEL2_n, . . . , VCSEL2_N according to a universal clock signal to synchronously encode X₁, X₂, . . . , Xₘ, . . . , X_{M} and W₁, W₂, . . . , Wₙ, . . . , W_{N}, respectively.

Based on the scheme of 2-fold fan-out, for computing Equation (8), the number of needed devices is M+N. The overall throughput T is 2×R×M×N, where R is the modulation speed of a vertical-cavity surface-emitting laser. As an example, if M is 1000, N is 1000, and R is 25 GigaS/s, then T is 50 PetaS/s, which is close to the order that a supercomputer can achieve.

According to the embodiment described above, the photonic integrated circuit (PIC) 100 for vertical optical computing (VOC) is used to provide a compact and robust solution for optical computing in AI/ML applications. To make the manufacturing process simple, the photonic integrated circuit (PIC) should exhibit a layered structure, which is realized by employing vertical-cavity surface-emitting lasers that can be optically injection-locked from their rear ends as well as by adopting phase encoding for input activations X and weighting factors W when performing homodyne detection; thus, all light beams involved in optical computing propagate in essentially the same direction.

The proposed configuration makes possible a CMOS-process-compatible photonic integrated circuit (PIC). In the proposed configuration, a 2-fold fan-out (W fan-out accompanied by X fan-out according to each W fan-out) is performed, which further enhances performance and energy efficiency potentially by 100× to 1000×, because now more Xs are processed simultaneously.

In our proposed configuration, light beams propagate in truly 3D space. Since photons can pass each other without affecting each other, our proposed configuration achieves the highest integration density; thus, the highest computation density.

According to one example embodiment, a photonic integrated circuit (PIC) is provided. The photonic integrated circuit includes a first 4f system, a leader laser, a first diffractive optical element (DOE), a second 4f system, a plurality of first vertical-cavity surface-emitting lasers (VCSELs), a plurality of second vertical-cavity surface-emitting lasers, a plurality of second diffractive optical elements, a third diffractive optical element, and a plurality of detectors. The leader laser is disposed at the object plane of the first 4f system. The first diffractive optical element is disposed at the pupil plane of the first 4f system. The plurality of first vertical-cavity surface-emitting lasers are disposed at the object plane of the second 4f system, which is also the image plane of the first 4f system. The plurality of second vertical-cavity surface-emitting lasers are disposed at the object plane of the second 4f system. The plurality of second diffractive optical elements are disposed at the pupil plane of the second 4f system. The third diffractive optical element is disposed at the pupil plane of the second 4f system. The plurality of detectors are disposed at the image plane of the second 4f system.

Based on the photonic integrated circuit described in the previous embodiments, the diffraction angles of the plurality of second diffractive optical elements are smaller than the diffraction angles of the third diffractive optical elements.

Based on the photonic integrated circuit described in the previous embodiments, the periods of the gratings on the plurality of second diffractive optical elements are larger than the periods of the gratings on the third diffractive optical element.

Based on the photonic integrated circuit described in the previous embodiments, the diffraction angles of the first diffractive optical element are substantially identical to the diffraction angles of the plurality of second diffractive optical elements.

Based on the photonic integrated circuit described in the previous embodiments, the number of the diffraction orders of each of the plurality of second diffractive optical elements is equal to or greater than N which is number of columns of a matrix of weighting factors; the number of the diffraction orders of the third diffractive optical element is equal to or greater than M which is number of sets of input activations.

Based on the photonic integrated circuit described in the previous embodiments, the number of the diffraction orders of the first diffractive optical element is equal to or greater than M+N.

Based on the photonic integrated circuit described in the previous embodiments, the first vertical-cavity surface-emitting lasers surround the second vertical-cavity surface-emitting lasers.

Based on the photonic integrated circuit described in the previous embodiments, the spacing among the first vertical-cavity surface-emitting lasers is larger than the spacing among the second vertical-cavity surface-emitting lasers.

Based on the photonic integrated circuit described in the previous embodiments, the second vertical-cavity surface-emitting lasers are arranged in a matrix.

According to one example embodiment, a photonic integrated circuit is provided. The photonic integrated circuit includes a leader laser, a first diffractive optical element, a plurality of first vertical-cavity surface-emitting lasers, a plurality of second vertical-cavity surface-emitting lasers, a plurality of second diffractive optical elements, a third diffractive optical element, and a plurality of detectors. The first diffractive optical element is disposed at a first plane. The plurality of first vertical-cavity surface-emitting lasers are disposed at a second plane. The plurality of second vertical-cavity surface-emitting lasers are disposed at the second plane. The plurality of second diffractive optical elements are disposed at a third plane. The second plane is located between the first plane and the third plane. The third diffractive optical element is disposed at the third plane. The plurality of detectors are disposed at a fourth plane. The third plane is located between the second plane and the fourth plane.

Based on the photonic integrated circuit described in the previous embodiments, the diffraction angles of the plurality of second diffractive optical elements are smaller than the diffraction angles of the third diffractive optical elements.

Based on the photonic integrated circuit described in the previous embodiments, the periods of the gratings on the plurality of second diffractive optical elements are larger than the periods of the gratings on the third diffractive optical element.

Based on the photonic integrated circuit described in the previous embodiments, the diffraction angles of the first diffractive optical element are substantially identical to the diffraction angles of the plurality of second diffractive optical elements.

Based on the photonic integrated circuit described in the previous embodiments, the number of the diffraction orders of each of the plurality of second diffractive optical elements is equal to or greater than N which is number of columns of a matrix of weighting factors; the number of the diffraction orders of the third diffractive optical element is equal to or greater than M which is number of sets of input activations.

Based on the photonic integrated circuit described in the previous embodiments, the number of the diffraction orders of the first diffractive optical element is equal to or greater than M+N.

Based on the photonic integrated circuit described in the previous embodiments, the first vertical-cavity surface-emitting lasers surround the second vertical-cavity surface-emitting lasers.

Based on the photonic integrated circuit described in the previous embodiments, the spacing among the first vertical-cavity surface-emitting lasers is larger than the spacing among the second vertical-cavity surface-emitting lasers.

Based on the photonic integrated circuit described in the previous embodiments, the second vertical-cavity surface-emitting lasers are arranged in a matrix.

According to one example embodiment, a method is provided. The method includes: providing an X matrix of m rows and a W matrix of n columns; multiplying the X matrix and the W matrix together over a time period, wherein the multiplying process comprises: encoding each column of the W matrix on a phase of a light beam from each of a group of n VCSELs over the time period; duplicating the light beams from the group of n VCSELs at least m times; encoding each row of the X matrix on a phase of a light beam from each of a group of m VCSELs over the time period; duplicating the light beam from each of the group of m VCSELs n times so that the n duplicated light beams are spatially overlapped with one of the duplicated copies of the light beams from the group of n VCSELs; accumulating charge over the time period at each detector pixel where two duplicated light beams are overlapped.

Based on the method described in the previous embodiments, the group of n VCSELs and the group of m VCSELs are injection locked by a leader laser; and the encodings of each row of the X matrix and each column of the W matrix are synchronized by a universal clock signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic integrated circuit, comprising:
a first 4f system;
a leader laser, disposed at an object plane of the first 4f system;
a first diffractive optical element, disposed at a pupil plane of the first 4f system;
a second 4f system;
a plurality of first vertical-cavity surface-emitting lasers, disposed at an object plane of the second 4f system, wherein the object plane of the second 4f system is same as an image plane of the first 4f system;
a plurality of second vertical-cavity surface-emitting lasers, disposed at the object plane of the second 4f system;
a plurality of second diffractive optical elements, disposed at a pupil plane of the second 4f system;
a third diffractive optical element, disposed at the pupil plane of the second 4f system; and
a plurality of detectors, disposed at an image plane of the second 4f system.

2. The photonic integrated circuit according to claim 1, wherein diffraction angles of the plurality of second diffractive optical elements are smaller than diffraction angles of the third diffractive optical element.

3. The photonic integrated circuit according to claim 1, wherein periods of gratings on the plurality of second diffractive optical elements are larger than periods of gratings on the third diffractive optical element.

4. The photonic integrated circuit according to claim 1, wherein diffraction angles of the first diffractive optical element are substantially identical to diffraction angles of the plurality of second diffractive optical elements.

5. The photonic integrated circuit according to claim 1, wherein number of diffraction orders of each of the plurality of second diffractive optical elements is equal to or greater than N which is number of columns of a matrix of weighting factors; number of diffraction orders of the third diffractive optical element is equal to or greater than M which is number of sets of input activations.

6. The photonic integrated circuit according to claim 5, wherein number of diffraction orders of the first diffractive optical element is equal to or larger than M+N.

7. The photonic integrated circuit according to claim 1, wherein the first vertical-cavity surface-emitting lasers surround the second vertical-cavity surface-emitting lasers.

8. The photonic integrated circuit according to claim 1, wherein spacing among the first vertical-cavity surface-emitting lasers is larger than spacing among the second vertical-cavity surface-emitting lasers.

9. The photonic integrated circuit according to claim 1, wherein the second vertical-cavity surface-emitting lasers are arranged in a matrix.

10. A photonic integrated circuit for vertical optical computing, comprising:
a leader laser;
a first diffractive optical element, disposed at a first plane;
a plurality of first vertical-cavity surface-emitting lasers, disposed at a second plane;
a plurality of second vertical-cavity surface-emitting lasers, disposed at the second plane;
a plurality of second diffractive optical elements, disposed at a third plane, wherein the second plane is located between the first plane and the third plane;
a third diffractive optical element, disposed at the third plane; and
a plurality of detectors, disposed at a fourth plane, wherein the third plane is located between the second plane and the fourth plane.

11. The photonic integrated circuit according to claim 10, wherein diffraction angles of the plurality of second diffractive optical elements are smaller than diffraction angles of the third diffractive optical element.

12. The photonic integrated circuit according to claim 10, wherein periods of gratings on the plurality of second diffractive optical elements are larger than periods of gratings on the third diffractive optical element.

13. The photonic integrated circuit according to claim 10, wherein diffraction angles of the first diffractive optical element are substantially identical to diffraction angles of the plurality of second diffractive optical elements.

14. The photonic integrated circuit according to claim 10, wherein number of diffraction orders of each of the plurality of second diffractive optical elements is equal to or greater than N which is number of columns of a matrix of weighting factors; number of diffraction orders of the third diffractive optical element is equal to or greater than M which is number of sets of input activations.

15. The photonic integrated circuit according to claim 14, wherein number of diffraction orders of the first diffractive optical element is equal to or larger than M+N.

16. The photonic integrated circuit according to claim 10, wherein the first vertical-cavity surface-emitting lasers surround the second vertical-cavity surface-emitting lasers.

17. The photonic integrated circuit according to claim 10, wherein spacing among the first vertical-cavity surface-emitting lasers is larger than spacing among the second vertical-cavity surface-emitting lasers.

18. The photonic integrated circuit according to claim 10, wherein the second vertical-cavity surface-emitting lasers are arranged in a matrix.

19. A method, comprising:
providing an X matrix of m rows and a W matrix of n columns;
multiplying the X matrix and the W matrix together over a time period, wherein the multiplying process comprises:
encoding each column of the W matrix on a phase of a light beam from each of a group of n VCSELs over the time period;
duplicating the light beams from the group of n VCSELs at least m times;
encoding each row of the X matrix on a phase of a light beam from each of a group of m VCSELs over the time period;
duplicating the light beam from each of the group of m VCSELs n times so that the n duplicated light beams are spatially overlapped with one of the duplicated copies of the light beams from the group of n VCSELs;
accumulating charge over the time period at each detector pixel where two duplicated light beams are overlapped.

20. The method according to claim 19,
wherein the group of n VCSELs and the group of m VCSELs are injection locked by a leader laser;
and wherein the encodings of each row of the X matrix and each column of the W matrix are synchronized by a universal clock signal.
